(19) United States
(12) Patent Application Publication
(10) Pub. No.: US 2008/0222272 A1
(43) Pub. Date: Sep. 11, 2008

(54) SYSTEM AND METHOD FOR SUBSTITUTING DATA IN RESPONSES TO MULTIMEDIA INQUIRIES

(75) Inventor: Roland Schoettle, American Canyon, CA (US)

Correspondence Address: FULBRIGHT & JAWORSKI L.L.P, 2200 ROSS AVENUE, SUITE 2800, DALLAS, TX, 75201-2784, US

(73) Assignee: Optimal Licensing Corporation, Freeport (BS)

(21) Appl. No.: 11/683,354

(22) Filed: Mar. 7, 2007

(51) Int. Cl. G06F 15/16

(52) U.S. Cl. 709/219

(57) ABSTRACT

The present invention is directed to using a gateway, through which a user uses a communication device such as a computer to access a network, to strip data from communications to the user from the network. The present invention also adds new data to the communication to the user from the network based on the demographics of the user. The demographics of the user may be accessed by or stored on the gateway thus avoiding the security issues of having said demographics being on the network.

### CROSS-REFERENCE TO RELATED APPLICATIONS

The present application is related to concurrently filed, co-pending, and commonly assigned U.S. patent application Ser. No. ______, Attorney Docket No. 66816/P012US/PENDING, entitled “SYSTEMS AND METHODS FOR LINKING UTILITY CONTROL DEVICES”; U.S. patent application Ser. No. ______, Attorney Docket No. 66816/P013US/PENDING, entitled “SYSTEM AND METHOD FOR INFRASTRUCTURE REPORTING”; U.S. patent application Ser. No. ______, Attorney Docket No. 66816/P014US/PENDING, entitled “LIGHT SWITCH USED AS A COMMUNICATION DEVICE”; U.S. patent application Ser. No. ______, Attorney Docket No. 66816/P015US/PENDING, entitled “SYSTEM AND METHOD FOR PREMISES MONITORING USING WEIGHT DETECTION”; U.S. patent application Ser. No. ______, Attorney Docket No. 66816/P016US/10614296, entitled “ANTICIPATORY UTILITY CONTROL DEVICE”; and U.S. patent application Ser. No. ______, Attorney Docket No. 66816/P017US/PENDING, entitled “PLUG AND PLAY UTILITY CONTROL MODULES”, the disclosures of which are hereby incorporated herein by reference.

### TECHNICAL FIELD

This disclosure is directed to the stripping of data, such as advertisements, from communications from the Internet or other audio/video/multimedia-capable network and replacing the stripped data with new data, at the edge of the network, preferably closer to the end-user.

### BACKGROUND OF THE INVENTION

As with television, cable, satellite and telecom networks before it, the Internet has become a primary means of communication. And as before, the Internet has become a major tool for entities to advertise goods and services. One form of such advertising involves the attachment of advertisements to web pages being returned to a user based on a request for information originating from the user. These advertisements are typically generic in nature and thus not particularly helpful to the user. In some instances, the advertisement that is returned is based upon the nature of the information requested by the user. The advertisements are necessarily generic because the information that would be required to download user-specific advertisements—the personal profile of the user-is not readily available to the servers that are attaching these advertisements to downloaded web pages. The same concept is true for other forms of media communications such as radio or television. For example, television advertisements rated for mature audiences only are not transmitted to a television located in a child's room, but are replaced with appropriate child-friendly advertisements or information.

### BRIEF SUMMARY OF THE INVENTION

The present invention is directed to using a gateway, through which a requesting user accesses the Internet, Television, Radio, or other Audio/Video network, to strip advertisements and other extraneous data from responses to a user or other communications sent to the user. The gateway accesses or stores demographic information of the user and then uses these demographics, in conjunction with the nature of the inquiry, to obtain new or substitute advertisements or other data in communications sent to the user. Note that the same approach can be used for groups of similar users and that different users can be members of different groups depending on the specific demographic(s) targeted as defining the group.

In one embodiment, the gateway uses the demographics of the user to download data from the same media source network or from another network during periods when the user is not logged onto the media source network. The media source network can be any of: Internet, television, cable, satellite, over-the-air, radio, telecom, or other Audio/Video/Multimedia network. The downloaded data would then be available to the user when the user next logs on to the media source network through the gateway to the end-point communication device such as a personal computer, television, radio, media server, or telephone. This previously downloaded information could be attached or inserted into media and network traffic streams if desired.

In another embodiment, the gateway uses the demographics of the user to download data from the same media source network or from another network while the user is using the media source network. As before, the media source network can be any of: Internet, television, cable, satellite, over-the-air, radio, telecom, or other Audio/Video/Multimedia network. The downloaded data would then be immediately available to the user through the gateway to the end-point communication device such as a personal computer, television, radio, media server, or telephone. This downloaded information could be attached or inserted into media and network traffic streams if desired.

The preferred embodiment uses digital multimedia data distributed via the Internet (as the media source network) to gate systems located closest to the end-users communication device. Where communication devices are also gateway systems, the gateway system is contained in the communication device.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawing, in which:

FIG. 1 is a block diagram illustrating one embodiment of the current invention;

FIG. 2 is a flow diagram illustrating one embodiment of the operation of the current invention;

### DETAILED DESCRIPTION OF THE INVENTION

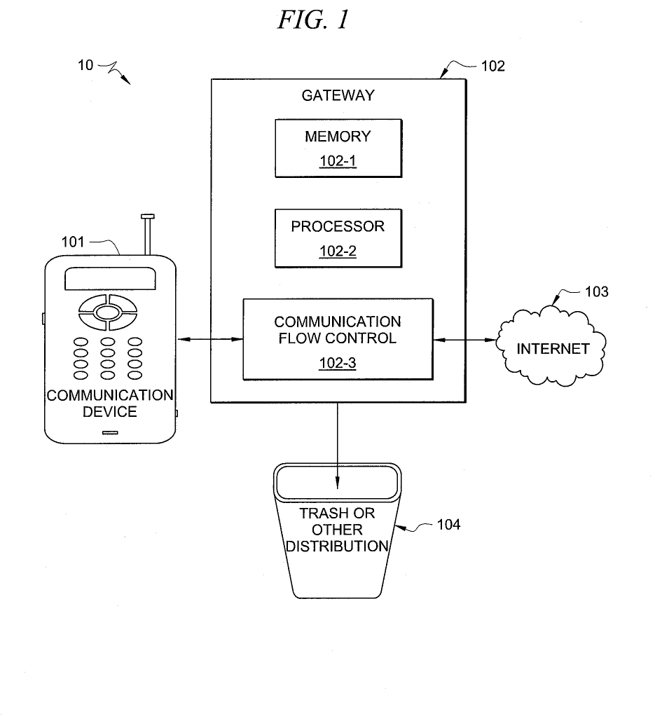

FIG. 1 is a block diagram illustrating one embodiment 10 of the current invention. A user accesses an electronic network such as the Internet 103, with a communication device such as a computer 101, through gateway 102. The communication device 101, gateway 102 and Internet 103 may be connected by wire, wireless or a combination thereof. Gateway 102 may have several functions including storing demographic information of the user in memory 102-1; stripping data such as advertisements attached to web pages coming from Internet 103, for example, by communications flow control 102-3; and adding new data to the web page before it goes to communication device 101. Adding advertisements or other data could also be by communications flow control 102-3 operating under control of processor 102-2 and in conjunction with memory 102-1.

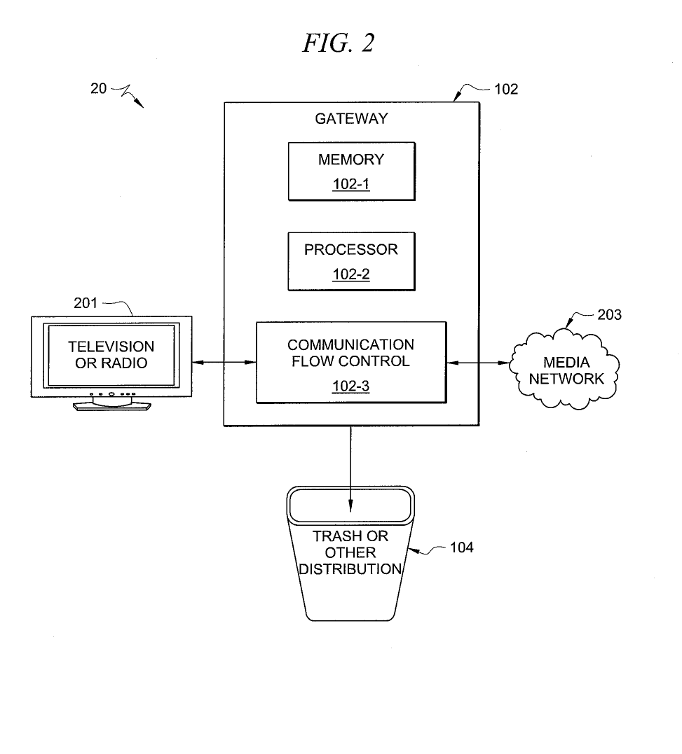

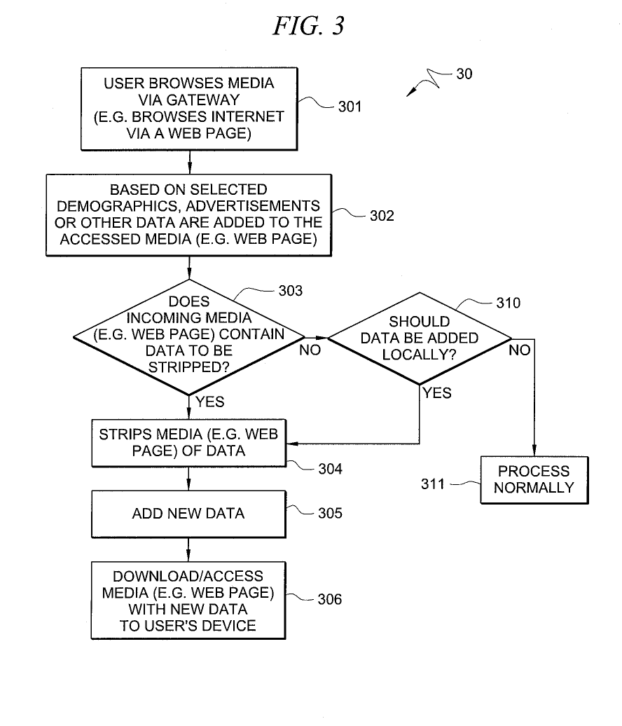

FIG. 2 is a block diagram illustrating another embodiment 20 of the current invention. A user accesses an electronic network such as a Television or Radio network (the media network), 203 with a communication device such as a Television or Radio 201, through gateway 102. The communication device 201, gateway 102 and media network 203 may be connected by wire, wireless or a combination thereof. Gateway 102 may have several functions including storing demographic information of the user in memory 102-1; stripping data such as advertisements attached to audio or video media streams coming from the media network 203, for example, by communications flow control 102-3; and adding new data to the media stream before it goes to communication device 206. Adding advertisements or other data could also be by communications flow control 102-3 operating under control of processor 102-2 and in conjunction with memory 102-1.

The user manages the demographic information accessible to or stored on gateway 102 and can provide as much or as little information as desired. Significantly, the demographic information stored on or accessible to gateway 102 is not on the Internet and thus avoids the potential lack of confidentiality associated with personal information being available to the public. In one embodiment, the gateway is a modem and could be located within communication device 101 or 201. Data, such as advertisements, stripped from the inbound communication can be sent to trash 104 or to another source. Trash 104 could, if desired, process the stripped data and send it on to device 101 or 201 perhaps at a later time or in a different form or with different parameters.

Note that while advertisements have been discussed herein, data of any nature can be stripped out of inbound communications and other data substituted therefor. The other data could be more appropriate for the user of device 101 or 201.

In some embodiments, the data to be added may be downloaded at a time when device 101 is not being used. This downloaded data can be stored, for example, in memory 102-1.

FIG. 3 is a diagram illustrating one embodiment 30 and shows a flow chart of one operation of the system shown in FIG. 1. Process 301 controls the accessing of the network (e.g. browsing on the Internet) by user via gateway 102. Process 302 adds data (e.g. advertisements) to the accessed media (e.g. web page). Process 303 determines if the incoming media (e.g. web page) contains data to be stripped. If not, then process 310 determines if data should be added locally. If no data is to be added locally in step 310, then the incoming data from the network (e.g. the Internet), as selected by the user, is processed normally at step 311, then delivered to the user's communication device via gateway 102. If data is to be stripped, then process 304 strips the data and process 305 adds new data in substitution for the stripped data or, when desired, the data is added to the unstripped downloaded file. The new file is then down loaded to the user via process 306. It should be noted that the processes reflected in FIG. 3 would be the same processes for media types such as video, audio, cable, television, radio, etc., each capable of communicating with a media network.

A practical example of the operation of one embodiment of the invention is where a user conducts a search via a search engine for make Y cars. The web page with the results of that search will typically have advertisements and links to dealers of make Y cars. However, those advertisements usually represent advertisements for dealers not in proximity to the user. At best, the web page may have advertisements for dealers in the same state as the user. If the user accessed the Internet through gateway 102, however, gateway 102 would be capable of providing advertisements more relevant to the user because gateway 102 stores the demographic information of the user. Specifically, gateway 102 would have stored or accessed the address of the user and therefore could download advertisements of dealers of car Y that are located close to the user's address.

Another practical embodiment of the invention is where a household has numerous television sets. One such Television could be in the children's bedroom while yet another could be in the workshop while yet another could be in the kitchen. With the addition of the gateway system, in which all traffic moves through, each TV set could be “tagged” as per user and user preferences (e.g., a; children in the child's bedroom where the system is set to never deliver mature content advertisements and otherwise replace these offending ads with wholesome ones, or b; to deliver home improvement or automotive ads instead of pharmaceutical ads to the handyman in the workshop) and for specific time based functions (e.g., send customized advertisements for healthy breakfasts and or cereals from local farms during the breakfast hours). Here again, gateway 102 would be capable of delivering advertisements more relevant to the user because gateway 102 would have stored or could immediately access the users preferences and therefore could deliver advertisements more beneficial to the user's.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A gateway for communicably connecting a communication device to a network comprising:
a processor operable for stripping certain data from information being downloaded from said network to said communication device; said stripping based, at least in part, on user demographics accessible by said gateway.

2. The gateway of claim 1 wherein said gateway is within a premises, said communication device being within said premises.

3. The gateway of claim 2 wherein said gateway is one of a plurality of gateways within said premises wherein said gateway is closest to said communication device.

4. The gateway of claim 1 wherein said gateway further comprises memory for storing said user demographics.

5. The gateway of claim 4 wherein said memory stores data to be added to said downloaded information.

6. The gateway of claim 5 wherein said gateway further comprises the ability to download said data to be added to said downloaded information.

7. The gateway of claim 1 wherein said processor is functionally operable for adding new data to said downloaded information from said network to said communication device, said new data based, at least in part, on said available user demographics.

8. The gateway of claim 7 wherein said new data is based, at least in part, on said information being downloaded from said network to said communication device.

9. The gateway of claim 7 wherein said new data is based, at least in part, on said information being downloaded from an alternate network to said communication device.

10. The gateway of claim 8 wherein said gateway, during periods when said communication device is not communicably connected to said network, downloads said new data to said communication device.

11. The gateway of claim 9 wherein said gateway, during periods when said communication device is not communicably connected to said network, downloads said new data to said communication device via an alternate network.

12. The gateway of claim 1 wherein said network is the Internet and said requested information is a web page.

13. The gateway of claim 1 wherein said network is the Internet and said requested information is an emergency message.

14. The gateway of claim 1 wherein said network is a cable television network and said requested information is a television advertisement.

15. The gateway of claim 1 wherein said network is a television network and said requested information is an audio message.

16. The gateway of claim 1 wherein said network is a television network and said requested information is a video message.

17. The gateway of claim 1 wherein said network is a television network and said requested information is an emergency message.

18. The gateway of claim 1 wherein said network is a cable radio network and said requested information is a radio advertisement.

19. The gateway of claim 1 wherein said network is a radio network and said requested information is an audio message.

20. The gateway of claim 1 wherein said network is a radio network and said requested information is an emergency message.

21. The gateway of claim 1 wherein said network is a telephone network and said requested information is an “on-hold” message.

22. The gateway of claim 1 wherein said network is a telephone network and said requested information is an audio message.

23. The gateway of claim 1 wherein said network is a telephone network and said requested information is a video message.

24. The gateway of claim 1 wherein said network is a telephone network and said requested information is an emergency message.

25. The gateway of claim 1 wherein said gateway is located in said communication device.

26. A software program operable in a gateway connecting a communication device to a network, said software program comprising:
code for processing information being downloaded from said network to a user at said communication device; and
code for stripping data from said information being downloaded from said network to said communication device, said stripping based, at least in part, on user demographics accessible by said gateway.

27. The software program of claim 26 further comprising code for replacing said stripped data with new data, said new data being dependent upon said demographics of said user.

28. The software program of claim 27 wherein said user demographics is stored in a memory of said gateway.

29. The software program of claim 27 wherein said new data is dependent, at least in part, upon said information being downloaded from said network to said communication device.

30. The software program of claim 27 wherein said new data is dependent, at least in part, upon said information being downloaded from a different network to said communication device.

31. The software program of claim 26 further comprising code for downloading said new data when said communication device is not communicably connected to said network.

32. The software program of claim 26 further comprising code for downloading said new data from a different network when said communication device is not communicably connected to said network.

33. A method comprising:
using a communication device to access information on a network via a gateway;
using said gateway to access demographics of a user;
using said gateway for stripping certain data from said information; and
using said gateway for adding new data to said information, said adding based, at least in part, on said demographics of the user.

34. The method of claim 33 wherein said network is the Internet and said information is a web page.

35. The method of claim 33 wherein said network is a television network and said information is an advertisement.

36. The method of claim 33 wherein said network is a television network and said information is an emergency message.

37. The method of claim 33 wherein said network is a radio network and said information is an advertisement.

38. The method of claim 33 wherein said network is a radio network and said information is an emergency message.

39. The method of claim 33 wherein said network is a telephone network and said information is an “on-hold” message.

40. The method of claim 33 wherein said network is a telephone network and said information is an advertisement.

41. The method of claim 33 wherein said network is a telephone network and said information is an emergency message.

42. The method of claim 33 wherein said gateway is located in said communication device.

43. The method of claim 33 wherein said gateway is located upstream of said communication device but within premises in which said communication device is located.

44. The method of claim 33 wherein said gateway is a modem.

45. The method of claim 33 wherein said gateway is a router.

46. The method of claim 33 wherein said gateway is a hub.

47. The method of claim 33 wherein said gateway is a wireless access point.

48. The method of claim 33 wherein said gateway is a set-top-box.

49. The method of claim 33 wherein said gateway is a media-center.

50. The method of claim 33 further comprising storing said demographics of said user in said gateway.

51. The method of claim 33 further comprising using said information to add said new data to said information.

52. The method of claim 33 further comprising downloading said new data during periods when said communication device is not communicably connected to said network.

53. The method of claim 33, wherein said gateway is one of a plurality of gateways within a premises and said gateway is closest to said communication device.
